(19) United States
(12) Patent Application Publication
(10) Pub. No.: US 2010/0073385 A1
(43) Pub. Date: Mar. 25, 2010

(54) DISPLAY CONTROL DEVICE AND DISPLAY CONTROL METHOD

(75) Inventor: Hidetomo MATSUO, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/388,291

(22) Filed: Feb. 18, 2009

(30) Foreign Application Priority Data
Sep. 19, 2008 (JP) 2008-241268

(51) Int. Cl. G09G 5/00

(52) U.S. Cl. 345/522

(57) ABSTRACT

A display control device includes a storage module which stores numbers of divisions to divide a display region of a display module in the vertical and horizontal directions; a graduation generation module which generates an image of graduations showing boundaries to divide the display region of the display module into the numbers of divisions in the vertical and horizontal directions; and a control module which displays the image of graduations generated in the graduation generation module, in the display region.

### CROSS-REFERENCE TO RELATED APPLICATIONS

This application is based upon and claims the benefit of priority from the prior Japanese Patent Application No. 2008-241268, filed on Sep. 19, 2008; the entire contents of which are incorporated herein by reference.

### BACKGROUND OF THE INVENTION

1. Field of the Invention

The present invention relates to a display control device and a display control method of displaying, on a screen, graduations as indexes to arrange an external device near a display module.

2. Description of the Related Art

An external device which outputs an image to a receiver is composed of, for example, a video game device or the like, and is operated in outputting an image by a wireless remote controller or the like. Therefore, a sensor which detects a radio signal may be placed at a predetermined position of the receiver. The sensor is often placed at middle positions in the vertical and horizontal directions of a screen of the receiver on which displays the image.

Conventionally, an image output device is disclosed which is composed of two screens and can arbitrarily change the proportions of the screen sizes. In this prior art, if the proportions of screen sizes of the two screens are equal, the middle position between the screens can be specified (see JP-A 2008-085546(KOKAI)).

### BRIEF SUMMARY OF THE INVENTION

In the above-described prior art, when the proportions of screen sizes of the two screens are changed, the middle position between the screens becomes hard to specify. In consideration of the above situation, an object of the present invention is to provide a display control device and a display control method capable of specifying the boundaries to divide the display region.

A display control device according to one aspect of the present invention includes a storage module which stores numbers of divisions to divide a display region of a display module in the vertical and horizontal directions; a graduation generation module which generates an image of graduations showing boundaries to divide the display region of the display module into the numbers of divisions in the vertical and horizontal directions; and a control module which displays the image of graduations generated in the graduation generation module, in the display region.

A display control method according to one aspect of the present invention includes storing numbers of divisions to divide a display region of a display module in the vertical and horizontal directions; generating an image of graduations showing boundaries to divide the display region into the numbers of divisions; and displaying the generated image of graduations in the display region of the display module.

### BRIEF DESCRIPTION OF THE DRAWINGS

FIG. 1 is a block diagram showing a display control system according to a first embodiment of the present invention.

FIG. 2 is a view showing a screen configuration of a display module in the first embodiment of the present invention.

FIG. 3 is a flow chart showing an example of operation of graduation display processing of a display control device according to the first embodiment of the present invention.

FIG. 4 is the same flow chart showing the example of operation of the graduation display processing.

FIG. 5 is a view showing a screen configuration of a display module in a modification example 1 of the first embodiment of the present invention.

FIG. 6 is a view showing a screen configuration of a display module in a modification example 2 of the first embodiment of the present invention.

FIG. 7 is a block diagram showing a display control system according to a second embodiment of the present invention.

### DETAILED DESCRIPTION OF THE INVENTION

Hereinafter, embodiments of the present invention will be described in detail with reference to the drawings.

### First Embodiment

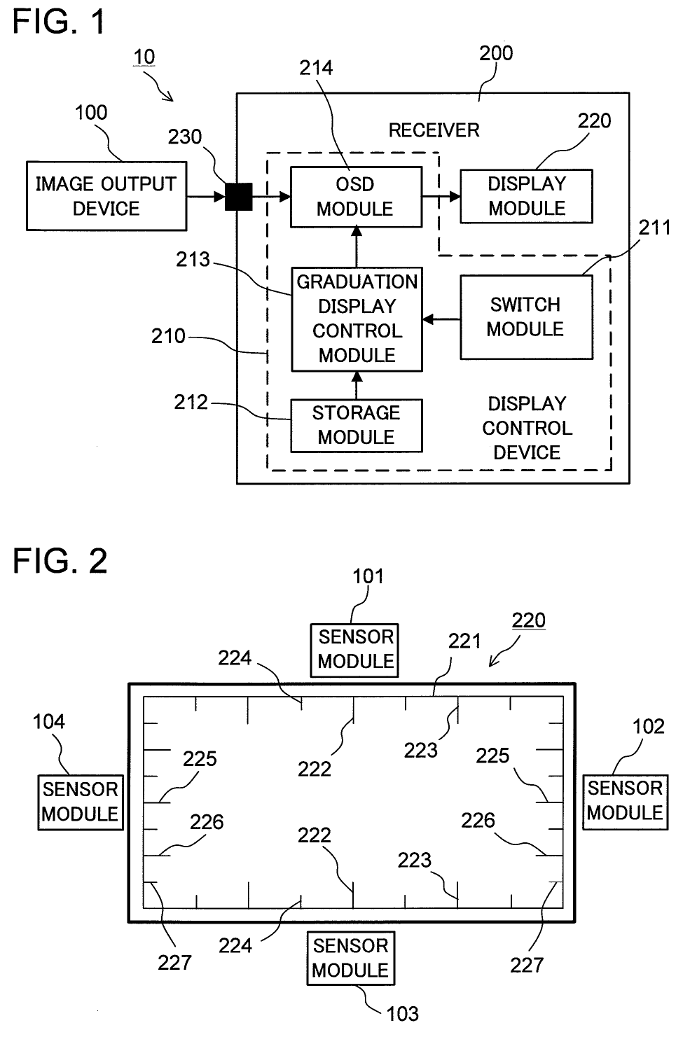

FIG. 1 is a block diagram showing a display control system 10 according to a first embodiment of the present invention. The display control system 10 comprises an image output device 100 composed of a video game device and so on, and a receiver 200.

The image output device 100 outputs an image based on detection signals obtained from a later-described plurality of sensor modules 101 to 104. The image output device 100 is electrically connected to the receiver 200 via an input terminal 230. The sensor modules 101 to 104 are arranged at middle positions of a display region 221 of a display module 220 (see FIG. 2). The sensor modules 101 to 104 detect radio signals transmitted from a radio attached, for example, to a human body.

The receiver 200 comprises a display control device 210 and the display module 220. This receiver 200 displays a screen of an image inputted from the image output device 100.

The display control device 210 comprises a switch module 211, a storage module 212, a graduation display control module 213, and an OSD (On Screen Display) module 214.

The switch module 211 judges whether or not an image of graduations generated in the graduation display control module 213 is displayed in the display region of the display module 220. The switch module 211 then switches between presence and absence of this display. Based on the result of judgment, the switch module 211 inputs a switching signal indicating a switching instruction into the graduation display control module 213. Note that when the image outputted from the image output device 100 is taken into the receiver 200, the image input into the receiver 200 needs to be switched using a remote controller or the like. The switch module 211 may switch between presence and absence of this display based on the switching of input into the receiver 200. Further, the switch module 211 may also perform the switching of input into the receiver 200. The switch module 211 functions as a switch module which switches between presence and absence of display of the image of graduations generated by the graduation display control module 213.

The storage module 212 stores the numbers of divisions to divide the screen in the display region 221 of the display module 220 in the vertical and horizontal directions. The numbers of divisions are previously inputted by a user or the like using a not-shown input module, and stored in the storage module 212. The numbers of divisions to be stored are, for example, “8” that is the same both in the horizontal and vertical directions of the screen in the display region 221 in the first embodiment, but may take of course different values. The storage module 212 functions as a storage module which stores the numbers of divisions for dividing the display region of the display module 220 in the horizontal and vertical directions. As the storage module 212, a semiconductor memory, a magnetic disk, an optical disk or the like can be used.

When the switching signal is inputted from the switch module 211, the graduation display control module 213 performs calculation processing to divide the screen in the display region 221 of the display module 220 based on the numbers of divisions and the widths in the vertical and horizontal directions obtained from the storage module 212. The graduation display control module 213 obtains first boundaries for division from the calculation result, and generates an image of graduations showing the first boundaries. Note that the vertical and horizontal widths of the screen are expressed by the numbers of pixels of the screen which have been previously defined.

The graduation display control module 213 further performs calculation processing to divide the display region 221 into two portions. The graduation display control module 213 obtains second boundaries for division into two portions from the calculation result, and generates an image of graduations showing the second boundaries. The graduation display control module 213 inputs the generated images of graduations showing the first and second boundaries into the OSD module 214. The graduation display control module 213 functions as a graduation generation module which generates an image of graduations showing boundaries to divide the display region into the numbers of divisions. Note that the graduations showing the boundaries for division into two portions may be made to be longer or thicker than those of other graduations or may be generated in a color different from that of other graduations for easy recognition by the user. Alternatively, the graduations showing the boundaries for division into two portions may be generated in combination of them (longer, thicker, and different color).

The OSD module 214 causes the display module 220 to display the images of the first and second graduations inputted from the graduation display control module 213. More specifically, the OSD module 214 superimposes the image inputted from the image output device 100 on the images of the first and second graduations generated in the graduation display control module 213. The OSD module 214 then inputs the superimposed images into the display module 220, and causes the display module 220 to display the images. The OSD module 214 functions as a control module which displays the images of graduations generated by the graduation display control module 213, in the display region. Note that the OSD module 214 has functions to perform, for example, adjustment of the luminance of a light source of the display module 220, adjustment of the contrast of the screen, and adjustment of the audio volume in addition to the above-described functions.

The display module 220 displays the image from the image output device 100 and the images of the first and second graduations which have been superimposed, in response to the display processing by the OSD module 214. As the display module 220, a liquid crystal display, a cathode ray tube (CRT), a plasma display or the like can be used.

FIG. 2 is a view showing a screen configuration of the display module 220 in the first embodiment. The display module 220 displays the images of graduations generated in the graduation display control module 213 with the images placed around the display region 221 of the screen, in response to the display processing by the OSD module 214. In this screen configuration, graduations 222 and 225 showing the second boundaries to divide the display region 221 into two portions both in the horizontal and vertical directions are displayed longer. Further, first graduations 223, 224, 226 and 227 showing the first boundaries to divide the screen in the display region 221 are displayed based on the numbers of divisions “8”. The even-numbered first graduations 223 and 226 are displayed longer here, and the odd-numbered first graduations 224 and 227 are displayed shorter than the graduations 223 and 226. Note that though the first graduations 223 and 226 at the middle positions of the display region 221 are superimposed on the second graduations 222 and 225, the second graduations 222 and 225 are preferentially displayed. In this case, it is also possible to display the second graduations 222 and 225 in a different color from that of other graduations (the first graduations 223, 224, 226 and 227), or display the second graduations 222 and 225 thicker than the other graduations. Alternatively, it is also possible to display the second graduations 222 and 225 in combination of them (longer, thicker, and different color).

### (Display Processing Operation)

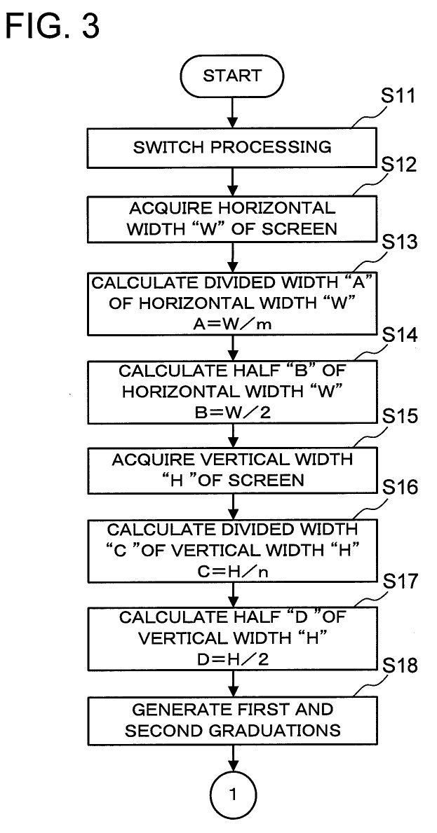

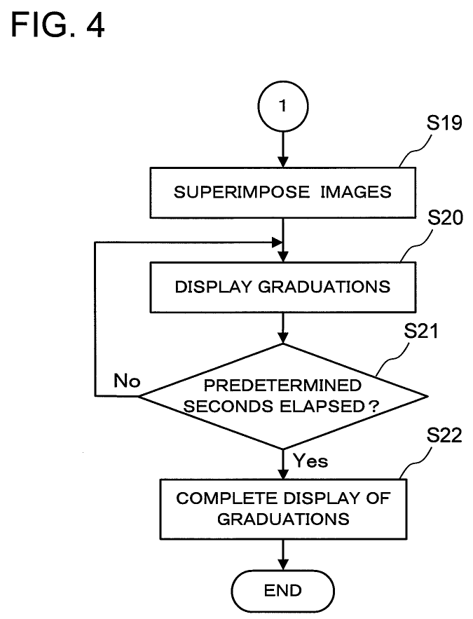

Next, a procedure of operation of the graduation display processing in the display control device 210 will be described. FIG. 3 and FIG. 4 are flow charts showing an example of the operation of the graduation display processing.

First, the switch module 211 inputs a switching signal into the graduation display control module 213 in order to display the images of graduations generated in the graduation display control module 213, in the display region of the display module 220 (Step S11).

When the switching signal is inputted, the graduation display control module 213 acquires a number of divisions “m” and a width “W” in the horizontal direction of the screen in the display region 221 from the storage module 212 (Step S12). The graduation display control module 213 calculates a width (hereinafter, referred to as a “divided width”) “A” obtained by dividing the horizontal width “W”, based on Expression “A=W/m (Step S13)”. The graduation display control module 213 further calculates a divided width “B” obtained by dividing the horizontal width “W” into two portions, based on Expression “B=W/2” (Step S14).

Next, the graduation display control module 213 acquires a number of divisions “n” and a width “H” in the vertical direction of the screen (Step S15). Note that “m=n=8” in the first embodiment. Then, the graduation display control module 213 calculates a divided width “C” of the vertical width “H” based on Expression “C=H/n” (Step S16). Then, the graduation display control module 213 calculates a divided width “D” obtained by dividing the vertical width “H” into two portions, based on Expression “D=H/2” (Step S17). Then, the graduation display control module 213 generates the images of the first and second graduations 222 to 227 based on the horizontal divided widths “A” and “B” of the screen and the vertical divided widths “C” and “D” of the screen which are the calculation results (Step S18). The generated first and second graduations 222 to 227 are inputted into the OSD module 214.

The OSD module 214 then superimposes the image inputted from the image output device 100 on the images of the first and second graduations generated in the graduation display control module 213 (Step S19).

The OSD module 214 then supplies the superimposed images to the display module 220 to display the images (the images including the images of graduations) (Step S20). The OSD module 214 then displays the graduations for predetermined seconds from start of the display of graduations (Step S21). Then, after a lapse of the predetermined seconds, the display of graduations is completed (Step S22).

As described above, in the display control device according to the first embodiment, the images showing the boundaries to divide the screen in the display region of the display module into predetermined numbers of divisions are displayed in the display region. As a result, the boundaries to divide the display region of the display module can be specified, so that the sensor modules 101 to 104 can be placed at predetermined positions around the display module, for example, at the middle positions of the screen.

### MODIFICATION EXAMPLE 1

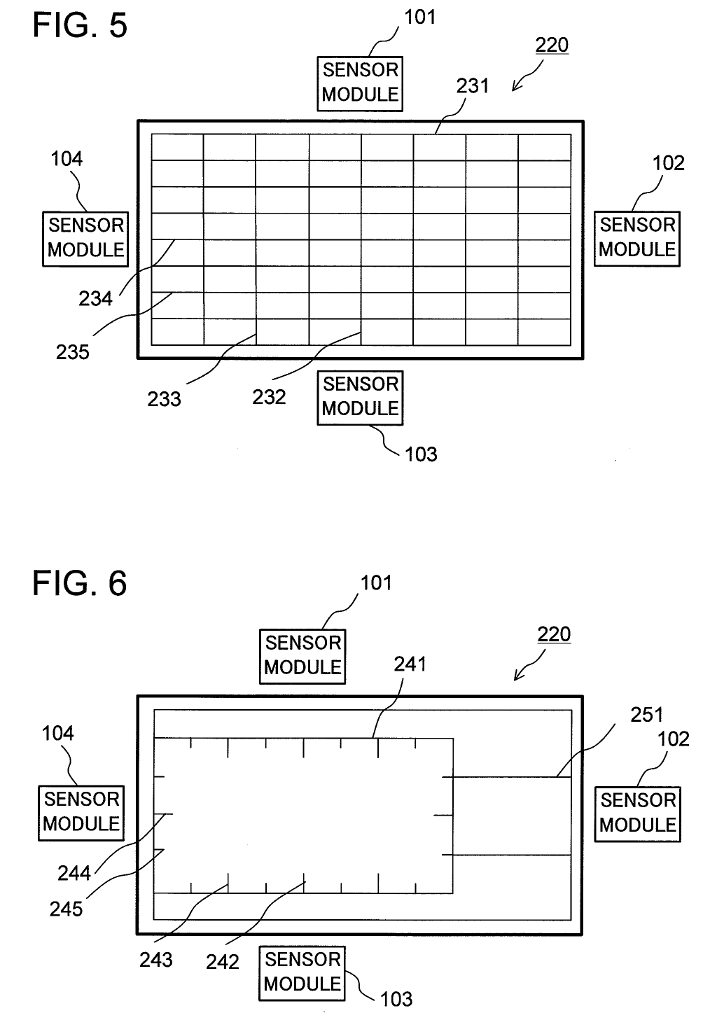

FIG. 5 is a view showing a screen configuration of a display module in a modification example 1 of the first embodiment. Though the images of graduations showing the boundaries for division are arranged around the display region of the display module in the first embodiment, the present invention is not limited to this arrangement.

In the modification example 1 of the first embodiment, the OSD module 214 displays the images of graduations generated in the graduation display control module 213 in a lattice form over the entire screen in a display region 231 of the display module 220. In this case, it is also possible to display second graduations 232 and 234 in a color different from that of other graduations (first graduations 233 and 235), or display the second graduations 232 and 234 thicker than the other graduations.

As described above, in the screen configuration of the display module in the modification example 1, the images of graduations are displayed in a lattice form over the entire screen in the display region. As a result of this, for example, even when the graduations are hardly recognized because the surroundings of the display region are dark, the boundaries to divide the display region can be easily specified, so that the sensor modules can be placed at predetermined positions around the display module.

### MODIFICATION EXAMPLE 2

FIG. 6 is a view showing a screen configuration of a display module in a modification example 2 of the first embodiment. FIG. 6 shows a screen configuration in the case where the display module 220 of the receiver 200 has a plurality of display regions. The modification example 2 is an example of a two-screen configuration in which the size of the display region can be changed, composed of, for example, a main screen in a display region 241 and a sub-screen in a display region 251, in which example the middle positions of the main screen are changed with a change in size.

In this modification example 2, when a switching signal for the main screen is inputted, the graduation display control module 213 generates an image of graduations showing boundaries to divide the display region 241 based on the numbers of divisions and the width of the screen in the display region 241. The OSD module 214 then displays the generated images of graduations around the display region 241 of the display module 220. Numerals 243 and 245 denote first graduations and numerals 242 and 244 denote second graduations.

Note that though the images of graduations are displayed on the main screen in the modification example 2, the present invention is not limited to this, but the images of graduations can also be displayed on the sub-screen in the display region 251. In this case, when the sub-screen is selected and a switching signal is inputted, the OSD module 214 displays the generated images of graduations around the display region 251 of the display module 220. In other words, it becomes possible to display the images of graduations for each of the display regions. Further, this modification example 2 is also applicable to a display module having a screen configuration composed of three screens or more.

As described above, in the modification example 2, in the case where the display module has a plurality of display regions, the images of graduations showing boundaries to divide one display region are displayed in the one display region. As a result of this, even when the size of the display region is changed, the images of graduations can be displayed in the display region when a switching signal is inputted, so that the sensor modules can be placed again using the graduations as indexes.

Note that the images of graduations as the indexes for placing the sensor modules are displayed in the display region in the first embodiment. However, when information indicating a position for placement of the sensor module is inputted, for example, from the image output device 100 or the like, an image such as a mark as the index can also be displayed directly at the position for placement of the sensor module on the screen in the display region. In this case, the position for placement of the sensor module can be more easily specified, so that the sensor module can be accurately placed.

### Second Embodiment

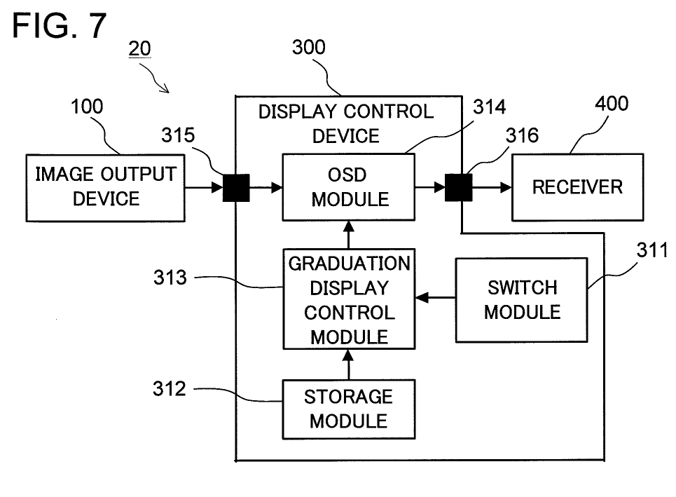

FIG. 7 is a block diagram showing a display control system 20 according to a second embodiment. This display control system 20 is an example in which an external device comprising an external input terminal 315 and an image output terminal 316 is used as a display control device 300. Examples of the external device include, for example, a recorder device having a not-shown storage module and so on.

The display control device 300 is electrically connected to the image output device 100 via the input terminal 315. Further, the display control device 300 is electrically connected to a receiver 400 via the output terminal 316. The receiver 400 comprises a not-shown display module.

A storage module 312 stores the numbers of divisions to divide the screen in the display region of the display module included in the receiver 400 in the vertical and horizontal directions, and the widths. A graduation display control module 313 generates images of first and second graduations showing boundaries to divide the display region of the display module based on the numbers of divisions and the widths. An OSD module 314 superimposes an image inputted from an image output device 100 on the images of the first and second graduations generated in the graduation display control module 313. The OSD module 314 then supplies the superimposed images to the receiver 400 to display the images of graduations.

Also in this display control system 20 according to the second embodiment, the boundaries to divide the display region of the display module can be specified as in the first embodiment, so that the senor modules can be placed at predetermined positions around the display module.

In the second embodiment, even if the receiver 400 has a breakdown, only the receiver 400 can be separately replaced with another while the display control device 300 is set up as it is. Then, in a display region of a display module included in the newly placed receiver 400, the graduations showing the boundaries to divide the display region can be displayed. As a result, replacement of devices can be made easy, so that the cost for replacement can be reduced.

### Other Embodiments

Embodiments of the present invention are not limited to the above-describe embodiments, but can be extended or changed, and the extended and changed embodiments are also included in the technical scope of the present invention.

What is claimed is:

1. A display control device, comprising:
a storage module configured to store numbers of divisions in order to divide a display region of a display in vertical and horizontal directions;
a graduation mark generator configured to generate an image of graduation marks showing boundaries dividing the display region of the display into the numbers of divisions in the vertical and horizontal directions; and
a controller configured to display the image of graduation marks generated in the graduation mark generator in the display region.

2. The display control device of claim 1, further comprising:
an image input module configured to receive an image input; and
a switch configured to switch between presence and absence of the generated image of graduation marks in the display region,
wherein the controller is configured to display the received image and the generated image of graduation marks superimposed in the display region, in response to switching by the switch.

3. The display control device of claim 1, wherein
the display comprises a plurality of display regions;
the storage module is configured to store the numbers of divisions in order to divide a first display region of the plurality of display regions in the vertical and horizontal directions;
the graduation mark generator is configured to generate an image of graduation marks showing boundaries dividing the first display region; and
the controller is configured to display the generated image of graduation marks in the first display region.

4. The display control device of claim 1, wherein the image of graduation marks comprises:
a first group of graduation marks showing the boundaries for the division; and
a second group of graduation marks showing boundaries dividing the display region into two portions.

5. The display control device of claim 1, wherein the image of graduation marks comprises:
a first group of graduation marks showing the boundaries for the division; and
a second group of graduation marks showing boundaries dividing the display region into two portions and being longer than the first group of graduation marks.

6. The display control device of claim 1, wherein the image of graduation marks comprises:
a first group of graduation marks showing the boundaries for the division; and
a second group of graduation marks showing boundaries dividing the display region into two portions and being thicker than the first group of graduation marks.

7. The display control device of claim 1, wherein the image of graduation marks comprises:
a first group of graduation marks showing the boundaries for the division; and
a second group of graduation marks showing boundaries dividing the display region into two portions and being in a color different from a color of the first group of graduation marks.

8. The display control device of claim 1, wherein the generated image of graduation marks is located around the display region of the display.

9. The display control device of claim 1, wherein the generated image of graduation marks is in a lattice form.

10. The display control device of claim 1, wherein the controller is configured to display the graduation marks in the display region of the display for a predetermined time.

11. A display control method, comprising:
storing numbers of divisions in order to divide a display region of a display in vertical and horizontal directions;
generating an image of graduation marks showing boundaries dividing the display region into the numbers of divisions; and
displaying the generated image of graduation marks in the display region of the display.

12. The display control method of claim 11, further comprising:
receiving an image; and
switching between presence and absence of the generated image of graduation marks in the display region,
wherein the displaying further comprises:
superimposing the received image and the generated image of graduation marks in the display region of the display, in response to the switching.

13. The display control method of claim 11,
wherein the storing further comprises:
storing numbers of divisions for dividing a first display region of a plurality of display regions comprised in the display in the vertical and horizontal direction;
wherein the generating further comprises:
generating an image of graduation marks showing boundaries dividing the first display region; and
wherein the displaying further comprises:
displaying the generated image of graduation marks in the first display region of the display.

14. The display control method of claim 11, wherein the generating further comprises:
generating the image of graduation marks comprising a first group of graduation marks showing the boundaries for the division and a second group of graduation marks showing boundaries dividing the display region into two portions.

15. The display control method of claim 11, wherein the generating step further comprises:
generating the image of graduation marks comprising a first group of graduation marks showing the boundaries for the division and a second group of graduation marks showing boundaries dividing the display region into two portions and being longer than the first group of graduation marks.

16. The display control method of claim 11, wherein the generating further comprises:
generating the image of graduation marks comprising a first group of graduation marks showing the boundaries for the division and a second group of graduation marks showing boundaries dividing the display region into two portions and being thicker than the first group of graduation marks.

17. The display control method of claim 11, wherein the generating further comprises:
generating the image of graduation marks comprising a first group of graduation marks showing the boundaries for the division and a second group of graduation marks showing boundaries dividing the display region into two portions and displayed in a color different from a color of the first group of graduation marks.

18. The display control method of claim 11, wherein the displaying further comprises:
locating the generated image of graduation marks around the display region of the display.

19. The display control method of claim 11, wherein the generating further comprises:
generating the image of graduation marks in a lattice form.

20. The display control method of claim 11, wherein the displaying comprises:
displaying the graduation marks in the display region of the display for a predetermined time.
